(19) United States
(12) Patent Application Publication
(10) Pub. No.: US 2002/0026329 A1
(43) Pub. Date: Feb. 28, 2002

(54) Health care information system

(76) Inventors: Minoru Saito, Kawasaki (JP); Ryosuke Imai, Kawasaki (JP); Hirofumi Masutani, Kawasaki (JP)

Correspondence Address: STAAS & HALSEY LLP, 700 11TH STREET, NW, SUITE 500, WASHINGTON, DC, 20001, US

(21) Appl. No.: 09/804,038

(22) Filed: Mar. 13, 2001

(30) Foreign Application Priority Data
Aug. 30, 2000 (JP) 2000-261631

(51) Int. Cl. G06F 17/60

(52) U.S. Cl. 705/3; 705/9

(57) ABSTRACT

Health care information system that stores information on referee medical institutions that are of relatively large size or otherwise having high-level expertise in specific diagnostic care and diseases, and based on information input by doctors at clinics or relatively small hospitals, selects appropriate referee medical institutions. Assistance is provided when the referrer medical institution sends a referral letter; and assistance is also provided when the referee hospital sends back patient examination reports. Information on hospitals (11), (12), . . . among referee medical institutions (1) is stored in a referee hospital information database (211) at a health care information center (2). Based on patient referral information from a referrer medical institution (3), an appropriate referee medical institution is selected, and information on the selected institution is presented to the referrer medical institution (3).

### BACKGROUND OF THE INVENTION

1. Technical Field

The present invention relates to a health care information system for handling, inter alia, diagnosis information, appointment information, and patient referral information; more specifically, it relates to a health care information system that makes possible safe and speedy linkup between clinic and hospital, and hospital and hospital.

2. Description of Related Art

Small hospitals and clinics may not have the specialists or testing equipment to handle a patient's condition. In such a case, a doctor at a referrer medical institution makes a referral by writing a referral letter to a hospital that has the proper specialist or testing equipment and sending this referral letter to the referee medical institution or having the patient bring it.

When a doctor at a clinic or similar institution writes a referral letter, she/he may first choose as the hospital for referral a hospital at which a doctor she/he knows is affiliated, or a hospital to which she/he has a personal connection; in other words, it is not always the case that the referral letter is written to the most appropriate hospital. And even if a doctor is able to learn of a hospital having a specialist or testing equipment that is appropriate in light of the results of a patient examination, if it is the first time that the hospital making the referral is making a patient referral with that hospital, it will have difficulty identifying the section and doctor to whom the referral letter should be addressed, and will have trouble making contact in order to schedule an appointment.

Moreover, when a clinic or hospital makes a patient referral to another hospital, it is convenient for the patient if the hospital making the referral could simultaneously set up an appointment. When a clinic or hospital schedules an appointment at a hospital being referred to, it usually does so by telephone or fax. When making an appointment by telephone, if the other party is not in, the appointment cannot be made, necessitating another call. Also, when making an appointment by telephone, because no appointment finalization information remains as a record, the appointment cannot be confirmed, and there is the danger of confusion resulting from overlapping appointments. When making an appointment by fax, the appointment cannot be confirmed at the same time, and the referee hospital must make contact to relay the message that the appointment has been finalized; this is troublesome work for both the hospital making the referral and the hospital being referred to.

Moreover, the doctor who made the diagnosis at the hospital making the referral must prepare a patient examination report containing diagnosis results, test results including x-rays and prescriptions for example, and must send this to the referee hospital or must have the patient bring it. When such a patient examination report is sent by mail, there is the danger of its not arriving at its destination, or the information being divulged during the sending process. When the patient brings the patient examination report, there is the danger the patient will learn of elements of the diagnosis that the doctor has not yet revealed to the patient.

### SUMMARY OF THE INVENTION

It is an object of the present invention to provide a health care information system that stores information on referee medical institutions that are relatively large or have specialists for certain diagnoses, treatments, or diseases; selects an appropriate referee medical institution based on examination information input by a doctor at a clinic or relatively small hospital; assists in the transmission of a referral letter from the medical institution making the reference; and also assists when a referee medical institution sends back a patient examination report.

The health care information system of the present invention comprises: referee hospital information storage means that stores hospital information, which includes such information as department information, information on doctors, hospital map information and the like on referee medical institutions, as patient referral destinations; examination information acceptance means that accepts patient information from referrer medical institutions, as patient referral sources; referee hospital information presentation means that selects appropriate medical institutions from the referee hospital information storage means based on examination information accepted by the examination information acceptance means, and that presents hospital information on the selected referee medical institutions to the medical institutions that refer patients; referral deciding means that accepts referee hospital decisions from the referrer medical institutions that refer patients; and patient referral information presentation means that creates patient referral information based on patient information accepted by the examination information acceptance means, and that sends the patient information to the referee medical institutions decided upon by the referral deciding means.

The system may be configured so as to further comprise electronic patient chart preparation means that prepares electronic patient charts based on patient information accepted by the patient information acceptance means, and referral creation means that creates letters of reference based on information input from the patient referral sources; wherein the patient referral information presentation means transmits to the referee medical institutions patient referral information containing electronic patient charts created by the electronic patient chart creation means attached to letters of reference created by the referral creation means.

The system may also be configured so that the patient referral information presentation means comprises reply method selection means that prompts the referrer medical institutions to select a reply method when examination information such as diagnostic results and prescriptions at the referee medical institutions is to be sent from the referee medical institutions to the referrer medical institutions, and that sends to the referee medical institutions information on the reply method selected by the reply method selection means, attached to the patient referral information.

Furthermore, the system may be configured to further comprise appointment information presentation means that presents to the referrer medical institutions the scheduling conditions of referee medical institutions; appointment acceptance means that has the referrer medical institutions decide on times and dates for appointments at the referee medical institutions; and appointment finalization means that sends to the referrer medical institutions the appointment dates and times accepted by the appointment acceptance means, and that finalizes the appointments.

In this case, the appointment information presentation means may be configured to comprise appointment information storage means that acquires and stores appointment conditions for the referee medical institutions.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a control block diagram summarizing the configuration of the first embodiment;

FIG. 2 is a control flowchart showing flow during operations;

FIG. 3 is a drawing for explaining the data structure of referee hospital information;

FIG. 4 is a drawing for explaining the data structure of membership information;

FIG. 5 is a drawing for explaining the data structure of diagnostic care department information;

FIG. 6 is a drawing for explaining the data structure of doctor information;

FIG. 7 is a drawing for explaining the data structure of map information;

FIG. 8 is a drawing for explaining the data structure of by-symptom hospital information;

FIG. 9 is a drawing for explaining the data structure of symptom classification master;

FIG. 10 is a drawing for explaining the data structure of hospital notice information;

FIG. 11 is a drawing for explaining the data structure of appointment information;

FIG. 12 is a drawing for explaining the data structure of health care information;

FIG. 13 is a drawing for explaining the data structure of email information;

FIG. 14 is a drawing for explaining the data structure of user information;

FIG. 15 is a drawing for explaining the data structure of patient information;

FIG. 16 is a drawing for explaining the data structure of appointment information for internal use;

FIG. 17 is a drawing for explaining the data structure of appointment information for referral use;

FIG. 18 is a drawing for explaining membership number input;

FIG. 19 is a drawing for explaining a service list screen;

FIG. 20 is a drawing for explaining a search screen;

FIG. 21 is a drawing for explaining a search results screen;

FIG. 22 is a drawing for explaining an appointment conditions screen;

FIG. 23 is a drawing for explaining an appointment conditions screen;

FIG. 24 is a drawing for explaining a referral letter creation screen; and

FIG. 25 is a drawing for explaining an appointment confirmation screen.

### DETAILED DESCRIPTION OF THE PREFERRED EMBODIMENTS

It is presumed that referee medical institutions are hospitals that have databases containing electronic patient charts and treatment information. Given this, the present invention is configured so that hospital information for this type of referee medical institution is stored in a database in a health care information center, and in response to an inquiry from a clinic, hospital or other referrer medical institution, an appropriate referee medical institution is selected, and hospital information for this referee medical institution is presented to the referrer medical institution. Appointment information can also be presented to the referrer medical institution, and the referrer medical institution can make appointments for examinations.

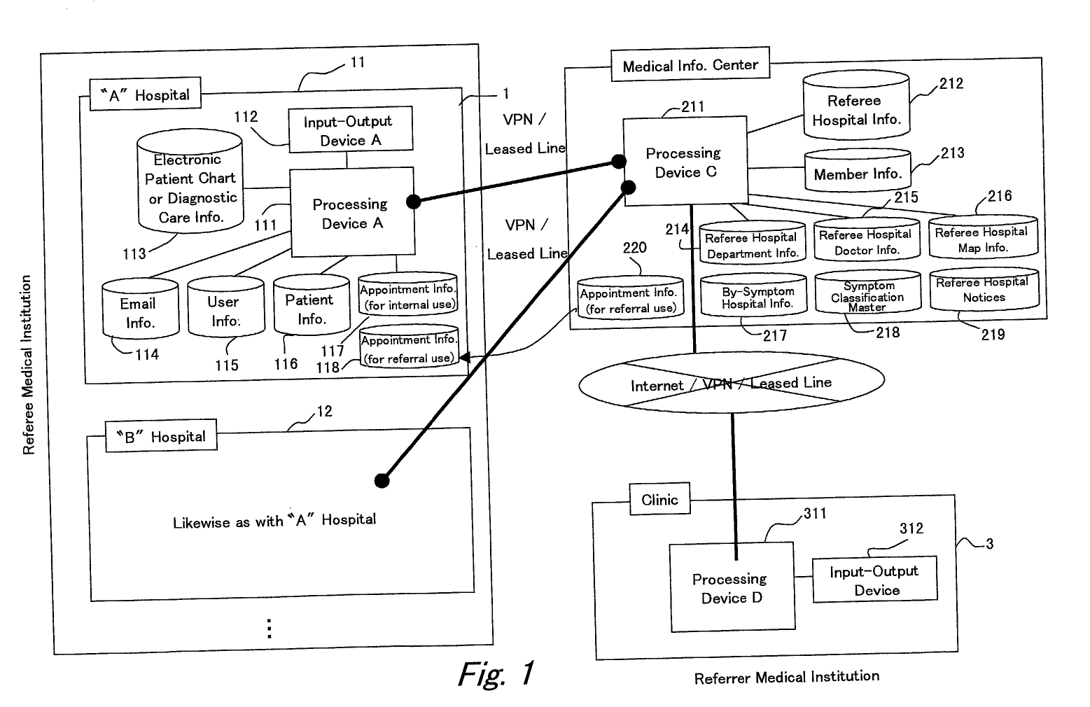

A first embodiment of the health care information system of the present invention will be explained while referring to FIG. 1.

Referee Medical Institutions

Among the referee medical institutions 1, “A” hospital 11 has a health care information database 113 relating to electronic patient charts or treatment information, as well as a processing device 111 that operates this health care information database 113. The processing device 111 can be, for example, a server within the hospital's LAN that operates the database system containing the health care information database 113.

The processing device 111 is interconnected with an input-output device 112 that may include, for example, input terminals for inputting such information as electronic patient chart and treatment information, patient information, appointment information, email information, user information and the like; display devices for displaying information; and printers.

In addition to the health care information database 113, the processing device 111 is interconnected to such databases as an email information database 114 storing email information, a user information database 115 storing user information, a patient information database 116 storing patient information, an appointment information for internal use database 117 storing appointment information for internal use and an appointment information for referral use database 118 storing appointment information for referral use. “B” hospital 12 included among the referee medical institutions 1 may have essentially the same configuration as “A” hospital 11, and an explanation thereof will be omitted. “A” hospital 11, “B” hospital 12, . . . included in the referee medical institutions 1 may constitute, for example, a plurality of hospitals associated with the same university, and the more points in common the respective systems in each hospitals have, the simpler operations will be.

The processing devices 111 at the hospitals 11, 12, . . . among the referee medical institutions 1 are each interconnected with a processing device 211 within a health care information center 2. This health care information center 2 is configured to store various types of information relating to the hospitals 11, 12, . . . within the referee medical institutions 1 and to present that information to referrer medical institutions.

Health Care Information Center

The health care information center 2 comprises a referee hospital information database 212 storing information on each of the hospitals among the referee medical institutions 1. A processing device 211 within the health care information center 2 is constituted by a server for operating this health care information system, and is interconnected with the processing devices 111 of the hospitals 11, 12, . . . among the referee medical institutions 1 over a virtual private network (VPN), a leased line or the like.

The processing device 211 is interconnected with a member information database 213 that manages information about members, i.e., referrer medical institutions.

The processing device 211 is also interconnected with such databases as a diagnostic care department information database 214 managing department information in the referee medical institutions, a doctor information database 215 managing information on doctors at the referee medical institutions, and a map information database 216 managing map information for the referee medical institutions.

Further, the processing device 211 is interconnected with a by-symptom hospital information database 217 for specifying referee medical institutions depending on the patient's symptoms and disease name, a symptom classification master 218 correlating symptoms and symptom classification codes, and a notice information database 219 for managing restrictions and other matters requiring attention concerning the referee medical institutions.

The health care information center 2 also comprises an appointment information database 220 for managing referral appointment information for the hospitals 11, 12, . . . among the referee medical institutions 1; this database is managed by the processing device 211.

Database Data Structure

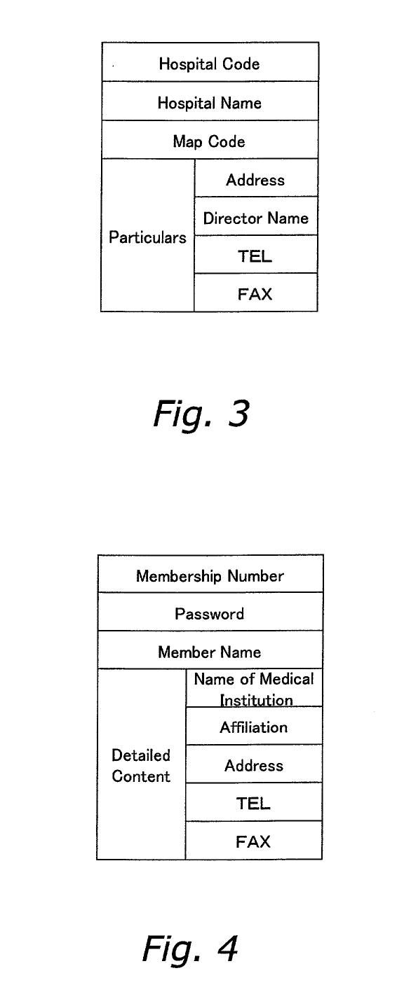

FIG. 3 shows one example of data structure in the referee hospital information database 212.

Hospital information for referee medical institutions used herein includes hospital code, hospital name, map code, and detailed content, with the detailed content including fields for address, director name, telephone number, and fax number. Through the input in advance of data into the above-described items when hospitals are being registered as referee medical institutions, the referee hospital information database 212 is constituted. Hospital information on these referee medical institutions can be updated periodically or can be updated as needed when there has been a change. The system may be configured so that data updates in the referee hospital information database 212 are performed by the referee medical institutions using the input-output device 112, or the updates can be performed by the health care information center 2.

FIG. 4 shows an example of the data structure of the member information database 213.

Data stored in the member information database 213 is registered information on a referrer medical institution 3 or on doctors belonging thereto; the data consists of such items as membership number, password, member name, detailed content, and the like. Detailed content comprises such fields as medical institution name, affiliations, address, telephone number, and fax number. The system can be configured so that when doctors at a referrer medical institutions wish to register as members, they are asked to enter the above-described membership information on a predetermined form, and this information is input at the health care information center 2, or the persons wishing to become members input the information themselves, using online signup.

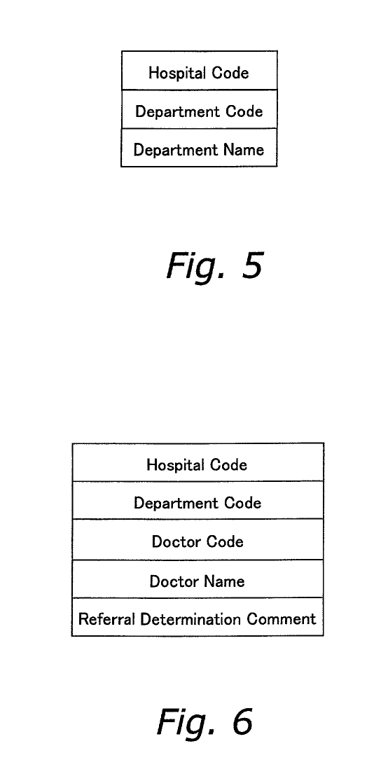

FIG. 5 shows an example of the data structure of the department information database 214.

This department information database 214 stores information detailing what sort of health care departments there are in the hospitals 11, 12, . . . among the referee medical institutions 1, and is constituted by fields for hospital code, diagnostic care department code and diagnostic care department field. This department information database 214, too, may be configured so that when registration is conducted for a referee medical institution, the relevant data is inputted along with referee hospital information, and updates can be made when there has been a change.

FIG. 6 shows an example of the data structure of the doctor information database 215.

Data on doctors belonging to the hospitals 11, 12, among the referee medical institutions 1 is stored in this doctor information database 215. The data structure comprises fields for hospital code, diagnostic care department code, doctor code, doctor name, comments for determining referral, for example. This doctor information database 215, too, may be configured so that when a medical institution is being registered as a referee medical institution with the health care information center 2, information on doctors belonging to that institution is input, and updates can be made when there has been a change.

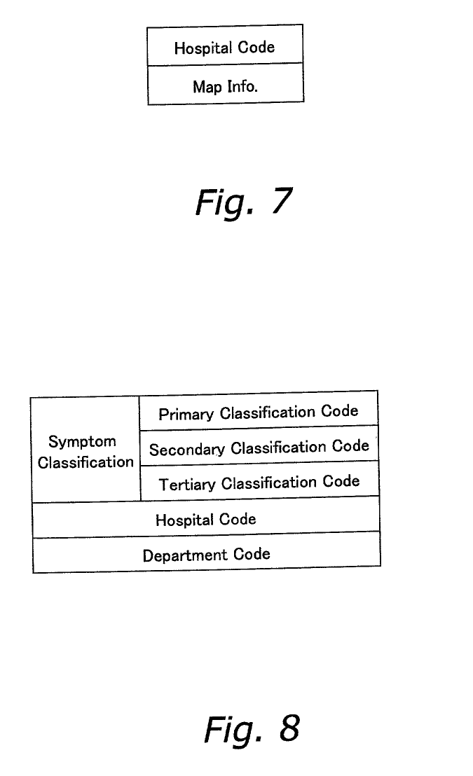

FIG. 7 shows an example of the data structure of the map information database 216.

The map information database 216 stores map information showing the location of the hospitals 11, 12, . . . among the referee medical institutions 1. Hospital code and map information fields constitute map information as used herein, and map data on the vicinity of referee medical institutions corresponding to the hospital codes is stored in the map information field. This map information may be information for links to map information databases available over the Internet for example.

FIG. 8 shows an example of the data structure of the by-symptom hospital information database 217.

The by-symptom hospital information database 217 is constituted by items for symptom classification, which comprises fields for primary, secondary and tertiary classification codes, hospital codes and diagnostic care department code. Input is made into each classification field, and the code for a hospital having a department capable of treating those symptoms are input together with a diagnostic care department code, forming the records for the by-symptom hospital information database 217. This by-symptom hospital information database 217, too, may be configured so that when referee hospital information is registered for a referee medical institution, the above data for the by-symptom hospital information database 217 is also input, and updates are made when there have been changes.

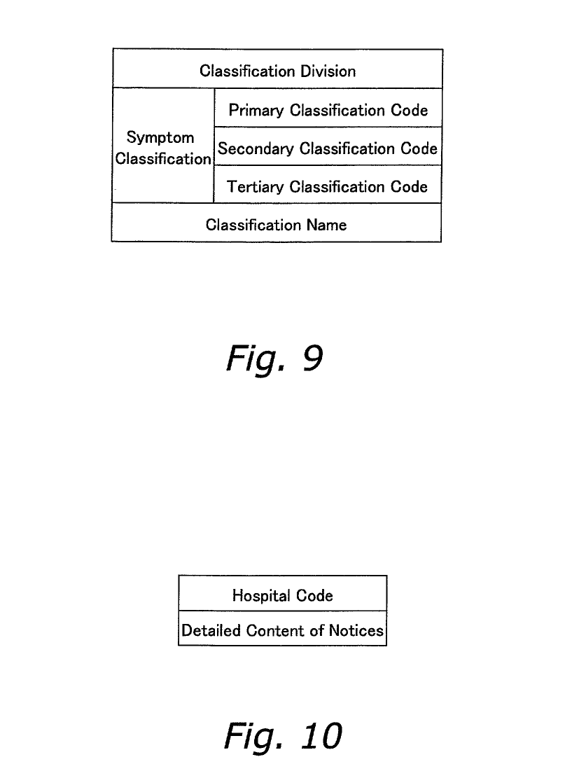

FIG. 9 shows an example of the data structure of the symptom classification master 218.

The symptom classification master 218 is constituted by division, symptom and name classification fields. Primary, secondary and tertiary classification codes are fields that make up the symptom classifications.

FIG. 10 shows an example of the data structure of the hospital notices database 219.

The hospital notices database 219 is constituted by hospital code and notice detailed content fields; restrictions and other items for attention pertaining to each of the referee medical institutions are stored in the notice detailed content field.

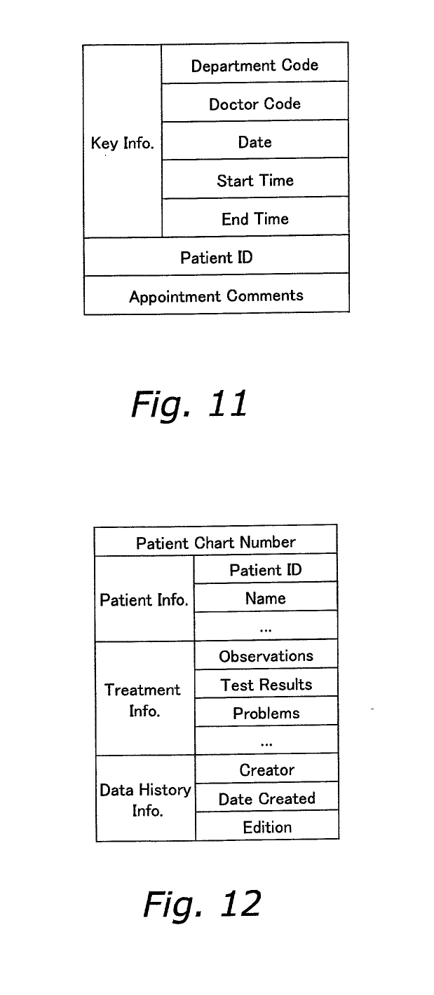

FIG. 11 shows an example of the data structure of the appointment information database 220.

The appointment information database 220 is constituted by items for key information, patient ID and appointment comment; the key information comprises such fields as diagnostic care department code, doctor code, date, start time, end time and the like. This appointment information database 220 links with the appointment information for referral use database 118 for hospitals 11, 12, . . . among the referee medical institutions 1. For example, time period data prepared by a referee medical institution as a schedule sheet for referrals is downloaded from the appointment information for referral use database 118 in one-month units into the appointment information database 220. When a referrer medical institution makes an appointment, this appointment information database 220 is updated. The system may be constituted so that the processing devices 111 at referee medical institutions access the contents of the updated appointment information database 220 every night, and update the contents of the appointment information for referral use database 118 based on the updated appointment information.

FIG. 12 shows an example of the data structure of the health care information database 113 in the hospitals 11, 12, . . . among the referee medical institutions 1. The health care information database 113 is constituted by an electronic patient chart and diagnostic information database, and therein includes items such as chart number, patient information, diagnostic information, and data history. Fields including patient ID and name constitute patient information. Fields including observation information, test results, and problems constitute diagnostic care information. Fields including creator, date of creation, and number of editions constitute data history information.

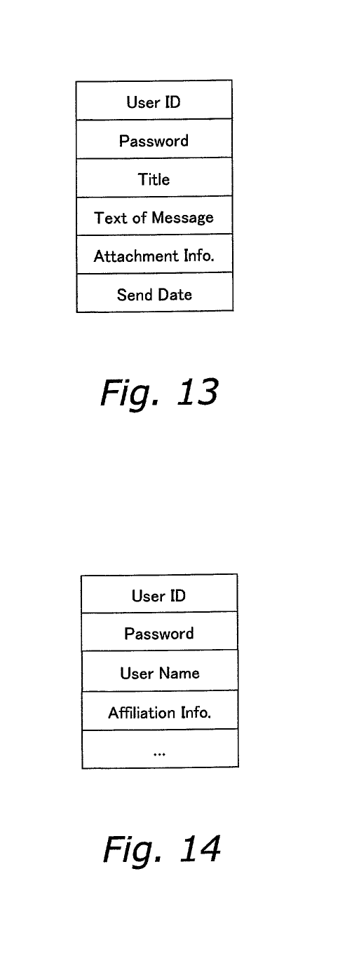

FIG. 13 shows an example of the data structure of the email information database 114.

Email information is composed of fields such as receiver information, sender information, title, text of message, attachments, and sending date.

FIG. 14 shows an example of the data structure of the user database 115.

User information is composed of fields such as user ID, password, user name, and affiliation information.

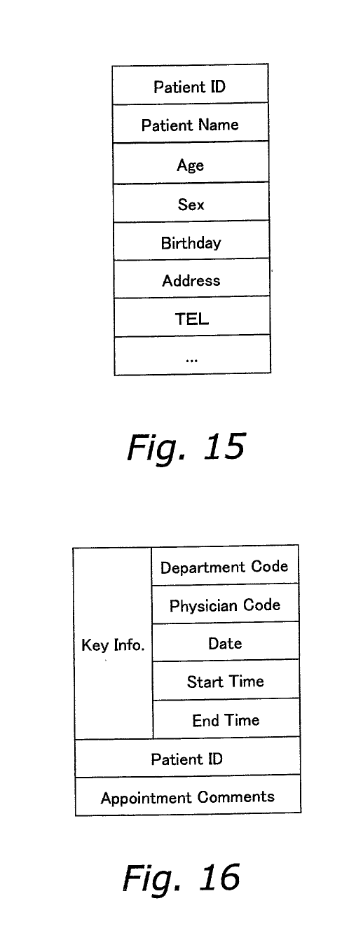

FIG. 15 shows an example of the data structure of the patient information database 116.

Patient information is composed of fields such as patient ID, patient name, age, sex, birthday, address, and phone number.

FIG. 16 shows an example of the data structure of the appointment information for in-house use database 117.

Appointment information for in-house use comprises items such as key information, patient ID, and appointment comments; key information comprises fields such as diagnostic care department code, doctor code, data, start time, and end time.

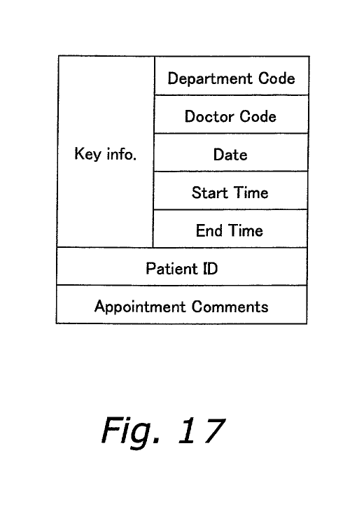

FIG. 17 shows an example of the data structure of the appointment information for referral use 118.

Appointment information for referral use may have the same data structure as the appointment information for internal use. It comprises such items as key information, patient ID, and appointment comments; key information may be constituted to comprise fields such as diagnostic care department code, doctor code, date, start time, and end time.

Referrer Medical Institution

A referrer medical institution 3 has a processing device 311 capable of accessing the health care information center 2 and an input-output device 312. The processing device 311 may be constituted by a computer terminal such as a personal computer or workstation comprising e.g., a modem or router to enable communication over the Internet, VPN, or leased line. Conceivable examples of the input-output device 312 include input machinery such as a keyboard or mouse, a display device making possible the display of data from the processing device 311, and a printer for printing data.

The processing device 311 is capable at accessing the processing device 211 of the health care information center 2 over the Internet, VPN or leased line.

Use of the Health Care Information Center by the Referrer Medical Institution

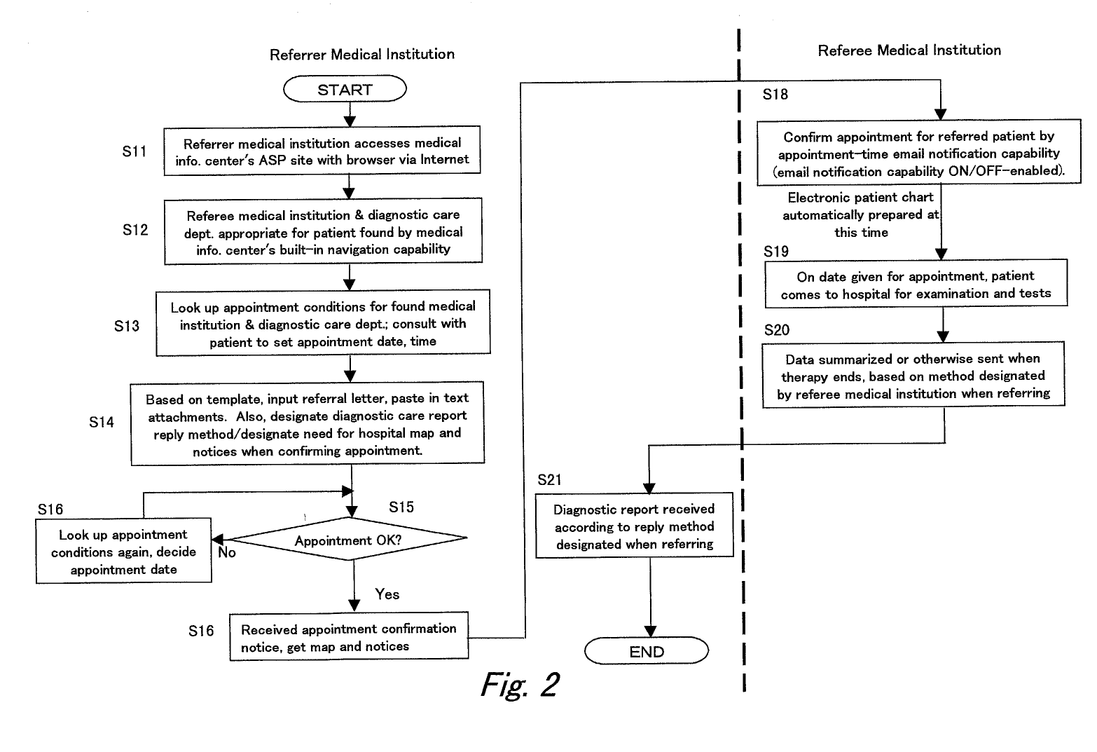

The flowchart of FIG. 2 shows operations when the referrer medical institution 3 accesses the health care information center 2 in order to search for a medical institution to which to refer a patient.

An application service provider (ASP) for supporting the operations systems of the hospitals 11, 12, . . . among the referee medical institutions 1 is provided within the health care information center 2; part of this ASP is accessible over the Internet as a clearinghouse for the patient referral system, and is configured to present hospital information for referee medical institutions in response to inquiries from the referrer medical institution 3.

The referrer medical institution 3, as a preliminary step, concludes a membership agreement with the health care information center 2 and applies for membership registration. This may take the form of online signup, performed from the processing device 311 at the referrer medical institution 3 over the Internet or other network, or a configuration is possible such that doctors or the like belonging to the referrer medical institution 3 apply using a predetermined form. The registered membership information is stored in the member information database 213, and at the same time membership number and password are set and stored in the member information database 213. Notification of the membership number and password information is made to the referrer medical institution 3 by mail or email for example.

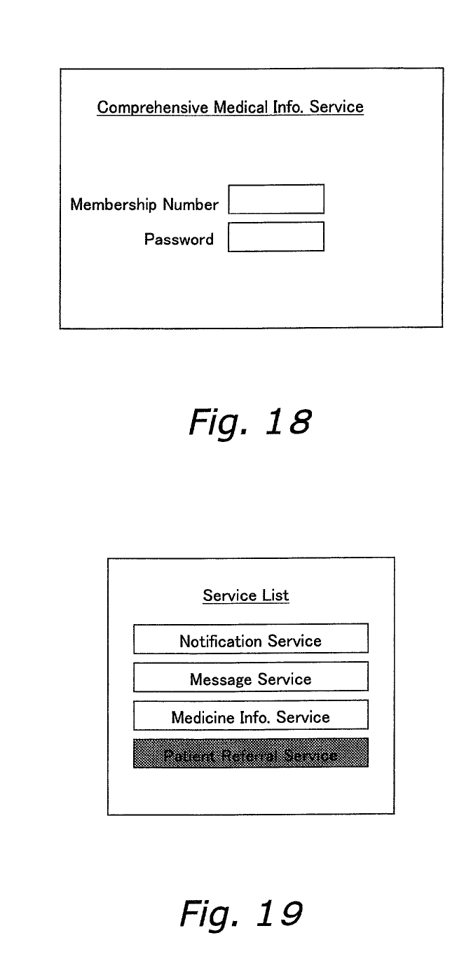

When the referrer medical institution 3 uses the patient referral system, it accesses the ASP for the referrer medical institution 3 in Step S11 of FIG. 2. Activating a browser such as Internet Explorer or Netscape Navigator with the processing device 311, the referrer medical institution 3 designates the URL of the health care information center 2 and connects with the health care information center 2. When there has been a connection request from the referrer medical institution 3, the health care information center 2 transmits to the processing device 311 a membership number input screen as shown in FIG. 18, and prompts the referrer medical institution 3 to input membership number and password.

The referrer medical institution 3 inputs the set membership number and password in the predetermined spaces on the displayed membership number input screen and transmits these to the health care information center 2. The health care information center 2 checks the received membership number and password, and if it judges that the membership number and password are correct, it sends the homepage of the ASP service to the processing device 311 ot the referrer medical institution 3 and causes it to be displayed there.

The homepage of the ASP service displays a service list as shown in FIG. 19. The referrer medical institution 3 may select any service displayed on the list; by selecting patient referral service, it can receive referee hospital information.

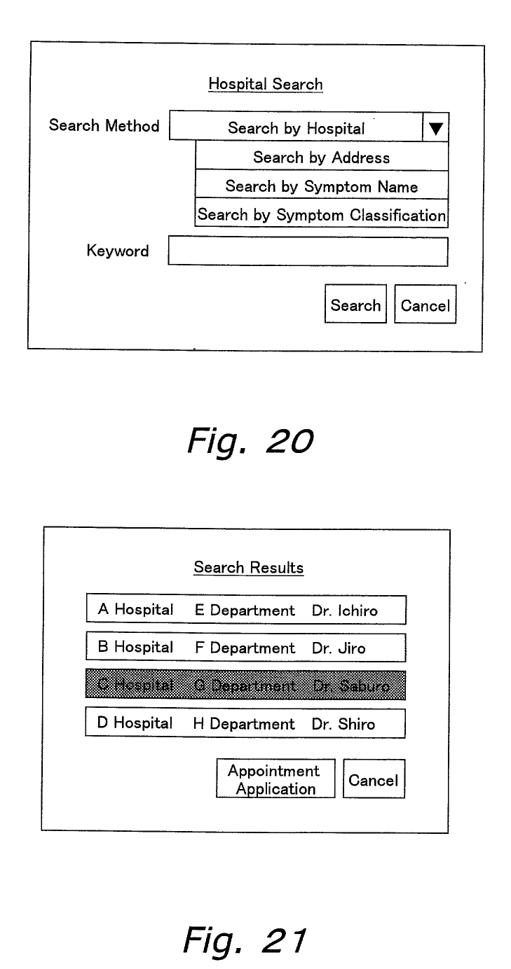

In Step S12, by using the navigation function in the patient referral service, the referrer medical institution 3 performs operations for obtaining information on a hospital appropriate for the patient in question. When patient referral service is selected from the displayed service list shown in FIG. 19, a hospital search display screen as shown in FIG. 20 appears.

The system may be configured so that on the hospital search display screen, input fields for, e.g. name of referee medical institution, address of referee medical institution, symptoms/disease name and symptom classification are displayed, and by making inputs in the various fields and clicking on the search button, the search is begun.

When designation has been made for a search to be conducted using name of referee medical institution, the health care information center 2 searches the referee hospital information database 212 using the inputted name of a referee medical institution, and a list showing the appropriate search results is displayed.

When designation has been made for a search to be conducted using address of referee medical institution, the health care information center 2 displays map information on the screen and prompts the referrer medical institution 3 to select a region. When selection of a region has been input, the selected region is displayed in expanded form, and the referrer medical institution 3 is again prompted to input selection of a region. When the selected region is limited to a region that is no greater than a predetermined size, a list of referee medical institutions within that region is displayed.

When designation has been made for search using symptoms/disease name, the symptom classification master 218 is searched using the input symptoms/disease name, and based on the corresponding symptom classification, the by-symptom hospital information database 217 is searched and a list of the diagnostic care departments of the relevant referee medical institutions is displayed.

When designation has been made for a search to be conducted by using symptom classifications, the primary symptom classifications are displayed, and the referrer medical institution 3 is prompted to select one of these. When the referrer medical institution 3 has selected a primary classification, the secondary classifications for the selected primary classification are displayed. When the referrer medical institution 3 has selected a secondary classification, the tertiary classifications for the selected secondary classification are displayed, and the referrer medical institution 3 is prompted to select one of these. Based on the symptom classification selected by the referrer medical institution 3, the by-symptom hospital information database 217 is searched, and a list of relevant diagnostic care departments at referee medical institutions is displayed.

These search parameters can be combined when making a search designation.

FIG. 21 shows an example of search results display. A list of hospital names, diagnostic care department names, and doctor names is displayed; a selection can be made by clicking on an item on this list.

The system may also be configured so that a diagnostic care department list is displayed showing hospital name and diagnostic care department; when a diagnostic care department is selected a list of doctor names appears, and then a doctor is selected. In this case, the system may be configured so that along with the display of doctor names, referral determination comments within the doctor information database 215 are displayed, providing the referrer medical institution 3 with standards upon which to make its determination.

In Step S13, hospital, diagnostic care department, and doctor name are selected from the displayed list of referee medical institutions, and after checking the appointment conditions therefor, a date and time for appointment are decided.

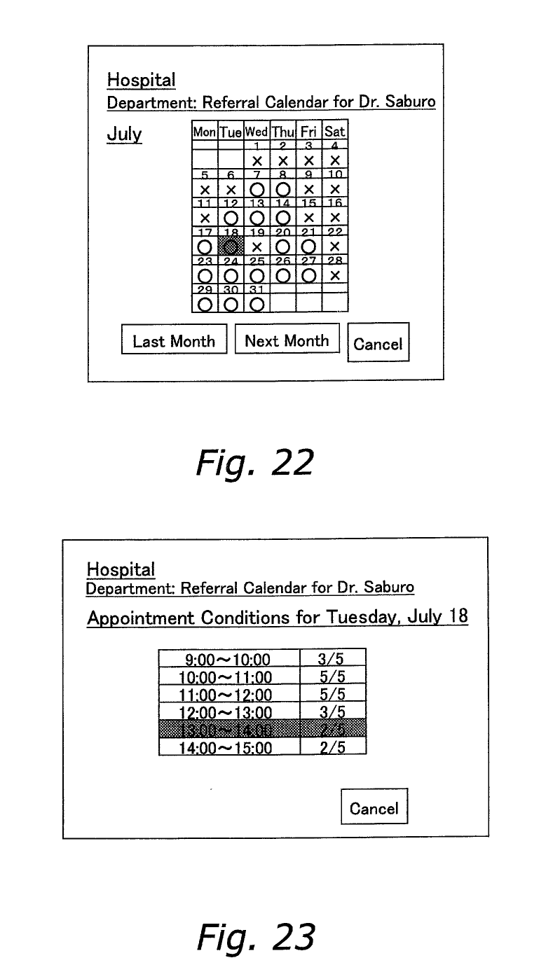

When an item in the list of the search results list as shown in FIG. 21 is selected and the appointment application button is clicked, an appointment conditions screen as shown in FIG. 22 appears. Shown here is an appointment conditions display screen showing appointment conditions for the selected doctor. Based on the contents of the appointment information database 220 obtained from the hospitals 11, 12, . . . among the referee medical institutions 1, dates open for an appointment are marked with an “O” and those not open are marked with an “X”.

When a desired date for an appointment is selected, a screen appears showing the appointment conditions for that date, as shown in FIG. 23. It is presumed here that a doctor can see five patients in an hour, and times marked “5/5” are not open for appointments, and times for which the left-hand number is below five are open for appointments. A doctor at the referrer medical institution consults with the patient regarding the appointment at the referee medical institution, and the time and date for the appointment are selected from the appointment conditions screen.

In Step S14, the referrer medical institution 3 inputs the referral letter and designates the diagnostic report reply method, and transmits this to the health care information center 2.

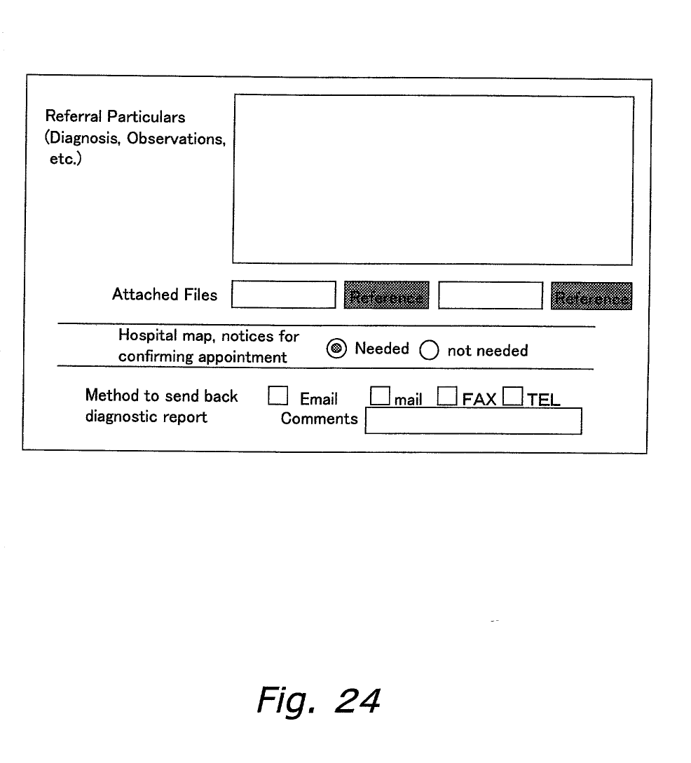

When determining the appointment date and time on the appointment conditions screen, a template screen for inputting a referral letter appears, as shown in FIG. 24. This template screen for inputting a referral letter comprises a referral detailed content column for inputting diagnosis, observations and the like, and an attachment file name input column when attaching a file such as document information, or image information such as test results. Further provided are, e.g. a radio button for selecting whether map information for the referee medical institution and notice information are needed when the appointment is confirmed, and a check column for designating the reply method for the diagnostic report. As reply methods for the diagnostic report, possible selections include email, mail, fax, and telephone, and a check box is provided for each of these.

In Step S15, determination is made whether the detailed content for the appointment is okay. At this point, the appointment detailed content are displayed again; if instructions are received from the referrer medical institution 3 indicating that the detailed content are accepted, then Step S17 ensues; if cancel instructions are received, Step S16 ensues.

In Step S16, the appointment conditions screen reappears, and a decision for appointment time and date is accepted.

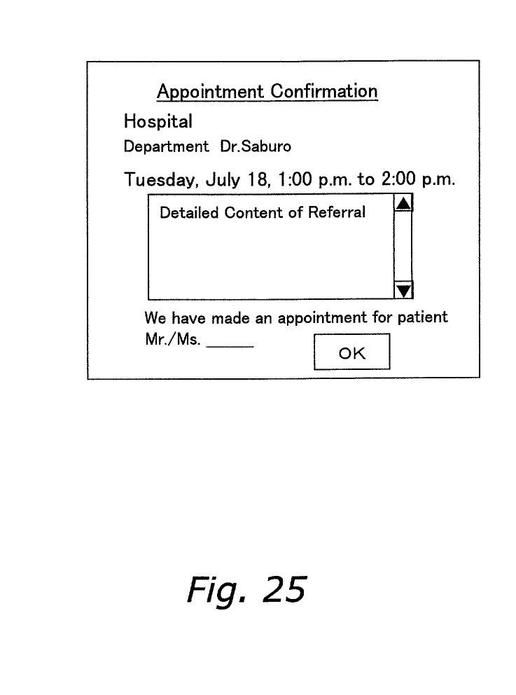

In Step S17, the health care information center 2 transmits to the referrer medical institution 3 an appointment confirmation notification in response to the appointment detailed content decided upon by the referrer medical institution 3. The appointment confirmation notification is displayed on an appointment confirmation screen as shown in FIG. 25. The appointment confirmation screen is constituted by the name of the referee medical institution, the diagnostic care department name, doctor name, appointment date and time, and referral detailed content, and it indicates that the appointment has been accepted with such detailed content. At this time, if instructions have been given to the effect that map information for the referee medical institution and notice information are needed, the health care information center 2 transmits to the referrer medical institution 3 information from the map information database 216 and the hospital notices database 219. The health care information center 2 also updates the contents of the appointment information database 220 based on the decided appointment detailed content.

Processing by the Referee Medical Institution

When appointment detailed content have been saved in the appointment information database 220, the health care information center 2 sends an email message for the doctor with whom the appointment has been made to the processing device 111 of the referee medical institution. This email message contains information on the referrer medical institution, information about the patient being referred, appointment information, and appointment detailed content. The processing device 111 at the referee medical institution stores the received email in the email information database 114 and notifies the doctor with whom the appointment has been made that the email has arrived.

At this time, the processing device 111 searches the patient information database 116 and determines whether the patient is already registered. If it determines that the patient is already registered, it adds the latest referral detailed content to the electronic patient chart in the health care information database 113 or to the treatment information database, and draws up an electronic patient chart. If it determines that the patient is not a registered patient, it draws up an electronic patient chart based on the readable information in the referral detailed content, and adds this to the patient information database 116 as a new record.

When an electronic patient chart is drawn up, the creator of the patient chart needs to be recorded. In this case, while the electronic patient chart was automatically created by the processing device 111 of the referee medical institution, based on the member information database 213 at referrer medical institutions managed by the health care information center 2, the membership ID of the referrer medical institution is recorded as the creator of the patient chart. The doctor at the referee medical institution can resolve the unnatural situation of having the creator of the chart be someone outside that hospital by changing the chart creator to him or herself when he or she opens the chart and confirms its contents when the patient comes to the hospital for the first examination.

In Step S19, when the referred patient comes to the hospital on the appointed day, examination, tests and the like are conducted. The examining doctor at the referee hospital uses the input-output device 112 to input examination results and test results, and this information is stored in the health care information database 113.

In Step S20, the referee hospital 1 sends the referrer medical institution 3 the diagnostic report. Based on test results, problems are stored in the health care information database 113, and a treatment summary is automatically drawn up by the processing device 111. A doctor at the referee medical institution 1 adds information to or deletes information from the automatically created treatment summary to complete the treatment summary. The treatment summary thus created is saved in the health care information database 113 and is sent to the referrer medical institution 3. This treatment summary is sent back in the manner that was designated beforehand, when the patient referral came from the referrer medical institution 3.

When the reply method is via email, the treatment summary is encrypted and sent to a doctor at the referrer medical institution 3. When the reply method is by mail, the processing device 111 prepares printed matter such as observations as well as the address label to be attached to an envelope, and outputs this to, e.g. the printer for the input-output device 112. The attending doctor of the referee medical institution 1 inserts the printed matter into the envelope, attaches the label, and mails the envelope.

When the reply method is by telephone, the display unit of the input-output device 112 displays instructions to reply by telephone and prompts the doctor to make the call. When fax has been designated as the reply method, the treatment summary is faxed to the doctor of the referrer medical institution 3 by the processing device 111.

In this manner, the treatment report sent from the referee medical institution arrives in Step S21 at the referrer medical institution 3.

The health care information system according to the present invention, by storing hospital information of referee hospitals and presenting this information to referrer medical institutions, allows for patients to be referred to the appropriate medical institution, and gives referrer medical institutions the capacity to make safe and prompt patient referrals.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A health-care information system comprising:
referee hospital information storage means for storing hospital information including diagnostic-care department information, information on doctors, and hospital map information on referee medical institutions as patient referral destinations;
examination information acceptance means for accepting patient information from referrer medical institutions as patient referral sources;
referee hospital information presentation means for selecting appropriate referee medical institutions from said referee hospital information storage means based on examination information accepted by said examination information acceptance means, and for presenting hospital information on the selected referee medical institution to said referrer medical institutions;
referral deciding means for accepting decisions on referee medical institutions from said referrer medical institutions; and
patient referral information presentation means for creating patient referral information based on patient information accepted by said examination information acceptance means, and for sending said patient referral information to the referee medical institutions decided upon by said referral deciding means.

2. The health-care information system set forth in claim 1, further comprising:
electronic patient chart preparation means for preparing electronic patient charts based on patient information accepted by said patient information acceptance means; and
referral creation means for creating letters of reference based on information input from said patient referral sources; wherein
said patient referral information presentation means transmits to said referee medical institutions patient referral information including electronic patient charts created by said electronic patient chart creation means attached to letters of reference created by said referral creation means.

3. The health-care information system as set forth in claim 1, said patient referral information presentation means comprising:
reply method selection means for having said referrer medical institutions select a reply method when at said referee medical institutions diagnostic results and diagnostic information including prescriptions is to be sent from said referee medical institutions to said referrer medical institutions; wherein
said patient referral information presentation means sends to said referee medical institutions information on the reply method selected by said reply method selection means, attached to said patient referral information.

4. The health-care information system as set forth in claim 1, further comprising:
appointment information presentation means for presenting to said referrer medical institutions scheduling conditions for said referee medical institutions;
appointment acceptance means for having said referrer medical institution decide on dates and times for appointments at said referee medical institution; and
appointment finalization means for finalizing appointments by sending to said referrer medical institutions the appointment dates and times accepted by said appointment acceptance means.

5. The health care information system as set forth in claim 4, wherein said appointment information presentation means comprises appointment information storage means for acquiring and storing appointment conditions for said referee medical institutions.
